(19) United States
(12) Patent Application Publication
(10) Pub. No.: US 2015/0244304 A1
(43) Pub. Date: Aug. 27, 2015

(54) SOLAR PHOTOVOLTAIC FACILITY

(71) Applicants: Syu-u OZEKI, Mito-shi (JP); Yuji HAMACHI, Mito-shi (JP)

(72) Inventors: Syu-u OZEKI, Mito-shi (JP); Yuji HAMACHI, Mito-shi (JP)

(73) Assignee: EIKOU CO., LTD, Mito-shi (JP)

(21) Appl. No.: 14/710,932

(22) Filed: May 13, 2015

Related U.S. Application Data
(63) Continuation-in-part of application No. 13/541,046, filed on Jul. 3, 2012.

(30) Foreign Application Priority Data
Jul. 4, 2011 (JP) 2011-148097

(51) Int. Cl. H01L 31/04; H02S 40/22

(52) U.S. Cl. CPC H02S 10/00; H02S 20/32; H02S 40/22

(57) ABSTRACT

A solar photovoltaic facility including: a construction having practically cylindrical shape and an utility space internally; a solar panel provided on cylindrical sidewall of the construction; a guide partially encompassing the construction and is practically concentric with the construction in plan view; a reflector movably guided by the guide and reflecting the sunlight towards the solar panel; a driving actuator which moves the reflector to a position in a direction opposite to the azimuth of the sun viewed from the construction; and an entrance installed on the sidewall of the construction within a range where the construction does not face the guide and accessible to the utility space.

### CROSS REFERENCE TO RELATED APPLICATION

This application is a continuation of U.S. application Ser. No. 13/541,046, filed Jul. 3, 2012, which claims priority on Japanese patent application No. 2011-148097, filed Jul. 4, 2011.

Japanese patent application laid-open No. JP 2011-155115 A published on Aug. 11, 2011, the content of which is hereby incorporated by reference into this application.

### BACKGROUND OF THE INVENTION

1. Field of the Invention

The present invention relates to a solar photovoltaic facility.

2. Description of the Related Art

FIG. 7 shows a solar power generation apparatus in the related art disclosed in JP2009-231315A. The solar power generation apparatus includes a solar cell panel body 101 formed in a spherical shape and a curved reflection plate 102, and can receive not only the sunlight which is directly incident to the solar cell panel body but also the sunlight reflected by the reflection plate on the rear surface side of the solar cell panel body.

In solar cell panels of the solar power generation apparatus disclosed in JP2009-231315A, a range to which the sunlight is directly incident easily deteriorates as compared with a range to which the sunlight is not directly incident, thus an efficiency of power generation by direct incidence will be reduced.

In addition, in the solar cell panels of the solar power generation apparatus disclosed in JP2009-231315A, a range which receives the sunlight reflected by the reflection plate is restricted, and thus it cannot be said that the sunlight is sufficiently used.

### SUMMARY OF THE INVENTION

An object of the present invention is to conveniently establish an environment for electric power use derived from the sunlight and utilize the sunlight in high efficiency throughout the year.

According to a representative aspect of the present invention, there is provided a solar voltaic facility including: a construction having practically cylindrical shape and an utility space internally; a solar panel provided on cylindrical sidewall of the construction; a guide partially encompassing the construction and is practically concentric with the construction in plan view; a reflector movably guided by the guide and reflecting the sunlight towards the solar panel; a driving actuator which moves the reflector to a position in a direction opposite to the azimuth of the sun viewed from the construction; and an entrance installed on the sidewall of the construction within a range where the construction does not face the guide and accessible to the utility space.

### BRIEF DESCRIPTION OF THE DRAWINGS

FIG. 1 is a perspective view illustrating a solar power generation apparatus according to a first embodiment of the present invention;

FIG. 2 is a perspective view illustrating a solar power generation apparatus according to a second embodiment of the present invention;

FIG. 3 is a side view illustrating a solar power generation apparatus according to a third embodiment of the present invention;

FIG. 4 is a side view illustrating a solar power generation apparatus according to a fourth embodiment of the present invention;

FIG. 5 is a perspective view illustrating a solar power generation apparatus according to a fifth embodiment of the present invention;

FIG. 6 is a side view illustrating a solar power generation apparatus according to a sixth embodiment of the present invention;

FIG. 7 is a side view illustrating a solar power generation apparatus in the related art;

FIG. 8 is a perspective view illustrating a solar power generation apparatus according to a seventh embodiment of the present invention;

FIG. 9 is a diagram illustrating the solar power generation apparatus according to the seventh embodiment of the present invention;

FIG. 10A is a perspective view illustrating an example of another aspect of the solar power generation apparatus according to the seventh embodiment of the present invention;

FIG. 10B is a cross-sectional view taken along a line XB-XB in FIG. 10A;

FIG. 11A is a plan view illustrating a solar power generation apparatus according to an eighth embodiment of the present invention;

FIG. 11B is a front view (partial cross-sectional view) illustrating the solar power generation apparatus according to the eighth embodiment of the present invention;

FIG. 12A is a plan view illustrating an example of another aspect of the solar power generation apparatus according to the eighth embodiment of the present invention;

FIG. 12B is a front view illustrating an example of another aspect of the solar power generation apparatus according to the eighth embodiment of the present invention;

FIG. 13 is a perspective view illustrating a solar power generation apparatus according to a ninth embodiment of the present invention;

FIG. 14A is a plan view illustrating the solar power generation apparatus according to the ninth embodiment of the present invention, shown in FIG. 13;

FIG. 14B is a front view (partial cross-sectional view) illustrating the solar power generation apparatus according to the ninth embodiment of the present invention, shown in FIG. 13; and

FIG. 15 is a perspective view illustrating a solar power generation apparatus according to a tenth embodiment of the present invention.

FIG. 16 is a schematic perspective view of the solar photovoltaic facility of the eleventh embodiment of the present invention.

FIG. 17 is a schematic plan view of the solar photovoltaic facility according to the eleventh embodiment of the present invention.

FIG. 18 is a schematic side view of the solar photovoltaic facility according to the eleventh embodiment of the present invention.

FIG. 19 is a side view of the reflector and the movable mount.

FIG. 20 is a partial cross-sectional vertical view of the reflector including the diffusion structure.

FIG. 21 is a schematic electric system diagram of the solar photovoltaic facility according to the eleventh embodiment of the present invention.

### DETAILED DESCRIPTION OF THE INVENTION

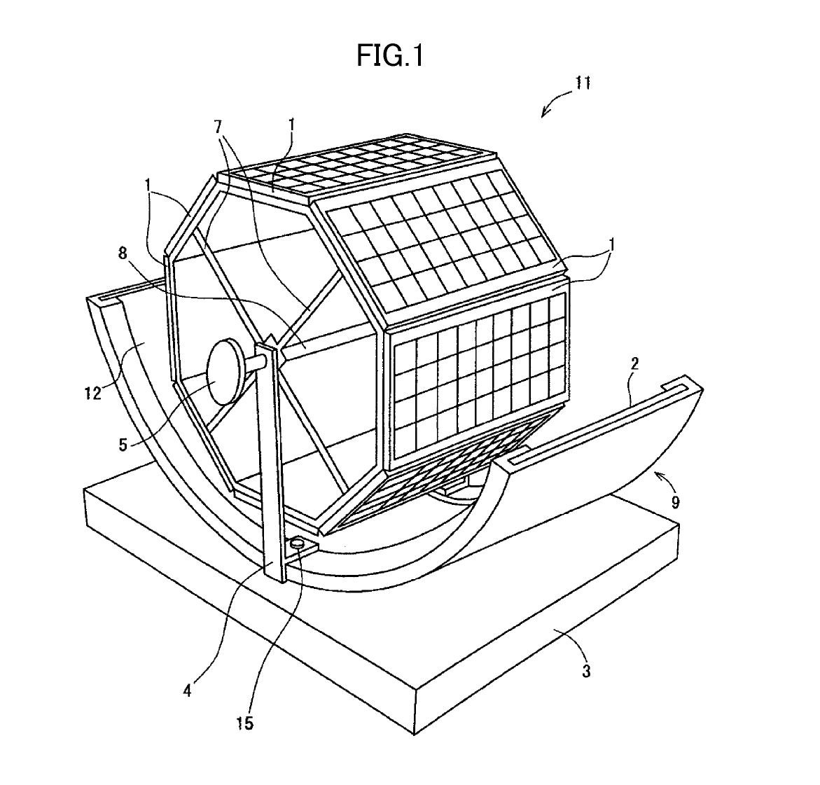

FIG. 1 shows a solar power generation apparatus according to a first embodiment of the present invention, and the solar power generation apparatus includes solar cell panels 1, a curved mirror 2, a rotation shaft 8, a handle 5, a base 3, and struts 4 vertically erected from the base 3.

The solar cell panel 1 is in a panel shape where plural solar cells which are power devices directly converting light energy into power using a photovoltaic effect are connected in series and in parallel and thereby necessary voltage and current can be obtained. A solar cell panel body 11 is obtained by disposing the solar cell panels 1 in an octagonal prism shape. The solar cell panel body 11 may be obtained by disposing the solar cell panels 1 in a polygonal prism shape or a cylindrical shape other than the octagonal prism shape.

The curved mirror 2 is a reflection plate which reflects the sunlight using a reflection surface 12, and the reflection surface 12 is formed to be concaved. A cross-section of the concaved surface has any curved shape, and may have a parabolic shape, an elliptical shape, or any polygonal line shape (hyperbolic shape, or combination of straight lines) other than the parabolic shape. The curved mirror may be a planar mirror, or a concaved surface mirror which collects light incident in parallel at one point, or may be constituted by a reflection plate where plural small-sized mirrors are arranged. The curved mirror 2 is held by a curved mirror holder 9 such that the periphery and the rear surface thereof are surrounded thereby. The curved mirror 2 is a glass mirror, but may be an acryl mirror, an aluminum mirror or a stainless steel mirror, and preferably has high reflectance.

The handle 5 is a rotation driving means for rotating the solar cell panel body 11 around the rotation shaft 8. The rotation driving means may rotate the solar cell panel body 11 using a motor or using some of power obtained through the solar power generation. In addition, an impeller may be provided at the rotation shaft 8, and the solar cell panel body 11 may be rotated by the force of the wind.

The base 3 has a cuboid shape, and two struts 4 having shaft supporters at front end parts are vertically erected from the base 3. In order to move the solar power generation apparatus, the traveling means such as wheels or caterpillars may be provided at the base 3.

The solar cell panel body 11 has supports 7 provided therein, and the supports 7 are installed at the rotation shaft 8. The rotation shaft 8 is rotatably installed at the shaft supporters provided at the front end parts of the struts 4, and the handle 5 is installed at the front end of the rotation shaft 8. The curved mirror holder 9 is disposed below the solar cell panel body 11 and is fixed to the struts 4 using bolts 15 such that the reflection surface 12 faces the solar cell panel body 11.

The solar power generation apparatus according to the first embodiment performs solar power generation using the sunlight which is directly incident to the solar cell panels 1, and performs solar power generation by irradiating the solar cell panels 1 which are not reached by the direct sunlight with light reflected by the curved mirror 2.

The solar power generation apparatus according to the first embodiment includes the solar cell panels 1 disposed in a tube shape and the curved mirror 2 and thus can generate power by irradiating the solar cell panels 1 which are not reached by the direct sunlight with reflected light. In addition, since the solar cell panels 1 are disposed in a tube shape, it is possible to reduce an installation area of the solar cell panels 1. Since the solar cell panel body 11 is rotated through rotation of the handle 5, the sunlight is prevented from being continuously directly incident only to some of the solar cell panels 1, and thereby it is possible to uniformly adjust deterioration in the solar cell panels 1.

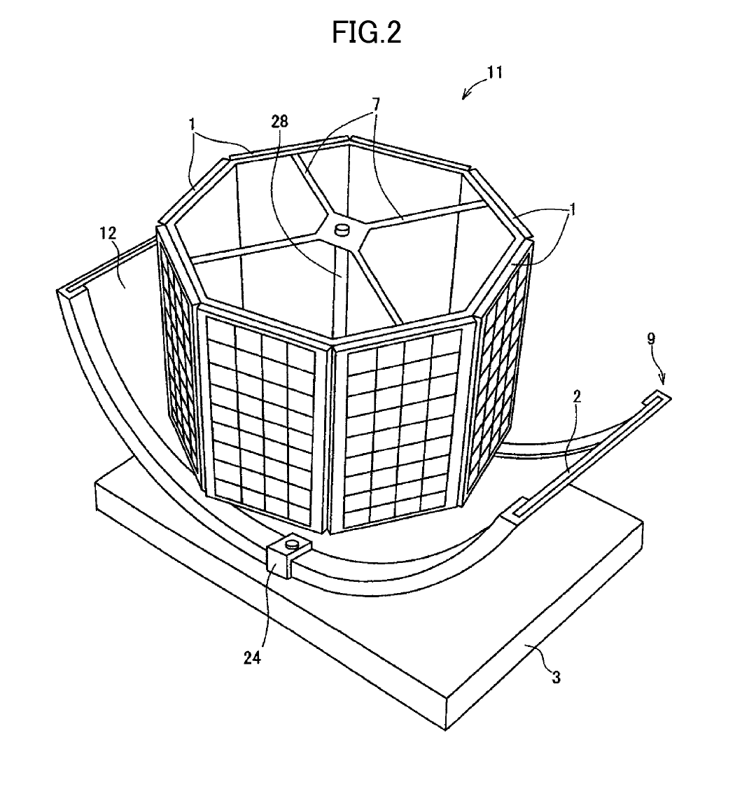

The solar cell panel body 11 shown in FIG. 1 may be configured such that, for example, as shown in FIG. 2, the tube shape of the solar cell panel body 11 is installed to be open in a vertical direction. At this time, a rotation shaft 28 is vertically erected from the base 3 and is installed so as to be rotated around an axis. The curved mirror holder 9 and the curved mirror 2 have through-holes (not shown) through which the rotation shaft 28 penetrates.

In the solar power generation apparatus according to the second embodiment, the rotation shaft 28 is installed so as to extend in the vertical direction, and thereby it is possible to pile up plural solar cell panel bodies 11 in the vertical direction. Thereby, it is possible to increase a power generation amount.

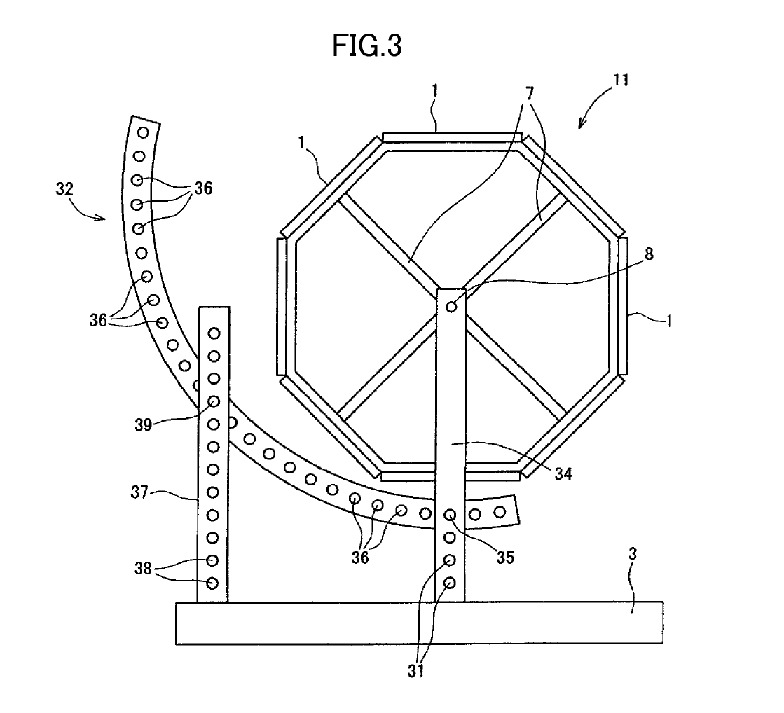

The installation means of the curved mirror holder 9 shown in FIG. 1 may use, for example, means shown in FIG. 3. A solar power generation apparatus shown in FIG. 3 includes a solar cell panel body 11, a base 3, a cradle 37 vertically erected from the base 3, a strut 34, and a curved mirror holder 32.

The cradle 37 and the strut 34 have a plurality of through-holes (or long holes) in the longitudinal direction, and the curved mirror holder 32 has a plurality of bolt holes 36 on its side surface. The curved mirror holder 32 is installed at the cradle 37 and the strut 34 using bolts. As an installation method thereof, a bolt 39 is screwed into the selected bolt hole 36 of the curved mirror holder 32 via a selected through-hole 38 of the cradle 37, and another bolt 35 is screwed into the selected bolt hole 36 of the curved mirror holder 32 via a selected through-hole 31 of the strut 34.

In the solar power generation apparatus shown in FIG. 3, the through-holes 38 of the cradle 37, the through-holes 31 of the strut 34, and the bolt holes 36 of the curved mirror holder 32 are selected according to the altitude of the sun, thereby adjusting an inclination angle and an installation position of the curved mirror 2. For this reason, it is possible to reflect the sunlight with high efficiency and perform solar power generation.

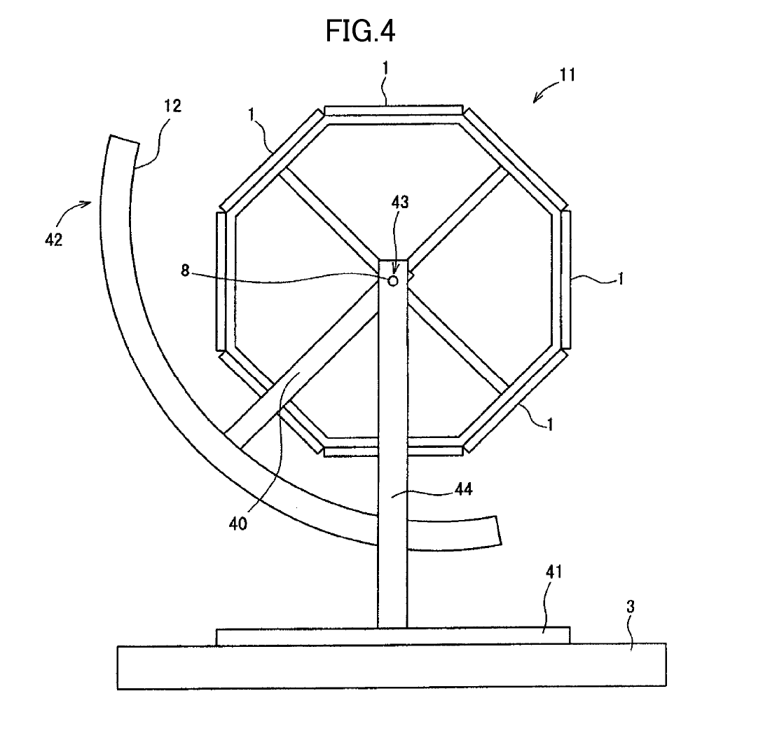

FIG. 4 shows a solar power generation apparatus according to a fourth embodiment which includes a solar cell panel body 11, a curved mirror 2, a rotation shaft 8, a strut 44, a swivel base 41, a sun position detecting means (not shown), an arm revolution driving means (not shown), a swivel base driving means (not shown), and a base 3.

The arm revolution driving means and the swivel base driving means are motors, and a motor such as a stepping motor which can control a rotation angle is preferable. Each driving means is electrically connected to the sun position detecting means so as to communicate with each other, and is operated in response to signals output from the sun position detecting means. The operation may be performed using some of power obtained through solar power generation.

The sun position detecting means includes a photodiode as a sensor, detects the position (azimuth and altitude) of the sun, and outputs a signal indicating the position. When the position of the sun cannot be detected due to the cloudy weather, the position of the sun may be predicted using a predefined calculation formula, the date, and installation place information.

The swivel base 41 is in a disc shape and is installed on the base 3 so as to be rotated in a circumferential direction. The swivel base driving means rotates the swivel base 41 in response to a signal indicating the azimuth output from the sun position detecting means, and is installed in the base 3.

A curved mirror holder 42 includes an arm 40 which is installed so as to extend perpendicularly from a central portion of the side surface thereof. A front end part of the arm 40 is installed at a shaft supporter 43 so as to be rotated around the rotation shaft 8. The arm revolution driving means is installed at the strut 44 so as to revolve the curved mirror holder 42 in response to a signal indicating the altitude output from the sun position detecting means.

The curved mirror 2 is held by the curved mirror holder 42 such that the periphery and the rear surface thereof are surrounded thereby, and a reflection surface 12 is disposed so as to face the solar cell panel body 11. The strut 44 is vertically erected on the rotation plate 41.

In the solar power generation apparatus according to the fourth embodiment, since the sun position detecting means can detect the position of the sun, the swivel base 41 can be rotated such that the solar cell panel body 11 faces the sun in response to a signal from the sun position detecting means, and the curved mirror holder 42 can be rotated such that the reflection surface 12 can face the sun. Therefore, it is possible to perform solar power generation with high efficiency.

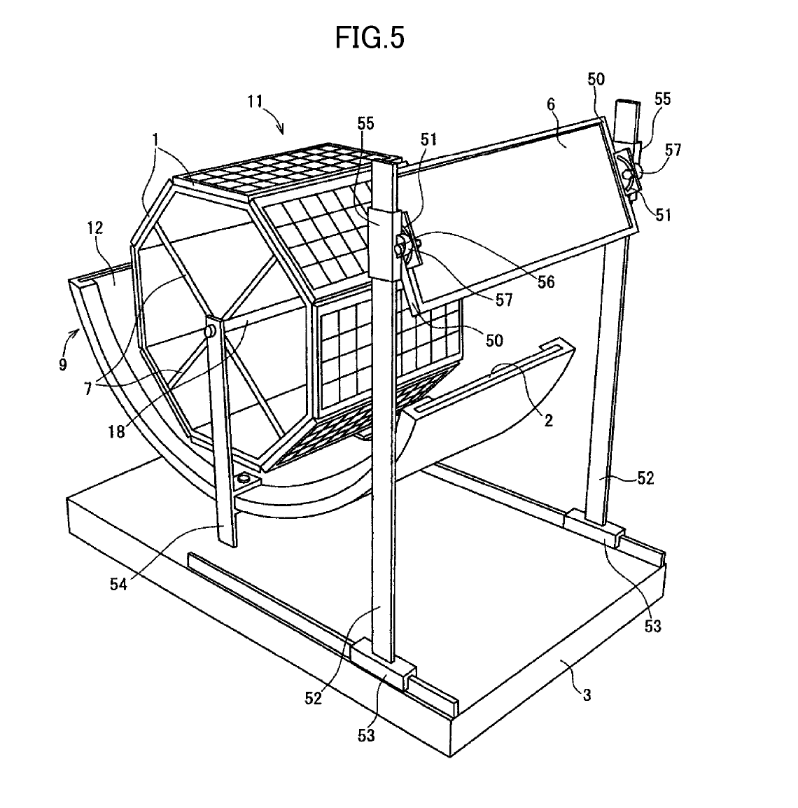

FIG. 5 shows a solar power generation apparatus according to a fifth embodiment, and the solar power generation apparatus includes a solar cell panel body 11, a curved mirror 2, a rotation shaft 18, a Fresnel lens 6, cradles 52, a rotating driving means (not shown), first sliders 53 which are installed on a base 3 so as to be movable in front and rear directions with respect to the solar cell panel body 11, and second sliders 55 which are movable in the longitudinal direction of the cradles 52.

The Fresnel lens 6 is used as a condensing lens which collects the sunlight at the solar cell panel body 11. A convex lens whose lens surface may be a spherical surface, or an aspherical surface such as a parabolic surface, an elliptical surface or a hyperbolic surface, may be used, or a cylindrical lens may be used. The Fresnel lens 6 is preferably a plastic lens made of PMMA, an acryl based resin or PC, and may be a lens made of glass such as BK7. In addition, the Fresnel lens 6 collects the incident sunlight in a strip shape but may collect the sunlight in a circular shape. The Fresnel lens 6 is in a rectangular plate shape but may be in a circular plate shape. It is preferable that the area of the plate be large in order to collect the sunlight more. The Fresnel lens 6 is held by a lens frame 50 such that the periphery thereof is surrounded thereby.

The lens frame 50 is rotatably installed at the second sliders 55 and is provided with angle maintaining long holes 51 in order to maintain an inclination angle. Bolts 56 are screwed into bolt holes of protrusions 57 which are formed at the second sliders 55 via the angle maintaining long holes 51, thereby holding the lens frame 50. The cradles 52 are vertically installed at the first sliders 53. The solar cell panel body 11 is installed at struts 54 so as to be rotated around the rotation shaft 18 by the rotating driving means (not shown) which is installed at the struts 54. The rotating driving means is a motor which continuously rotates the solar cell panel body 11 at a constant speed and is operated using some of power obtained through the solar power generation.

In the solar power generation apparatus according to the fifth embodiment, an inclination angle of the lens frame 50 can be adjusted, and thus an incidence angle of the sunlight to the Fresnel lens 6 can be adjusted. In addition, since a distance between the Fresnel lens 6 and the solar cell panel body 11 can be adjusted by the first sliders 53 and the second sliders 55, it is possible to adjust a condensing range of the sunlight depending on a size of a solar cell panel 1 and to thereby perform solar power generation with high efficiency.

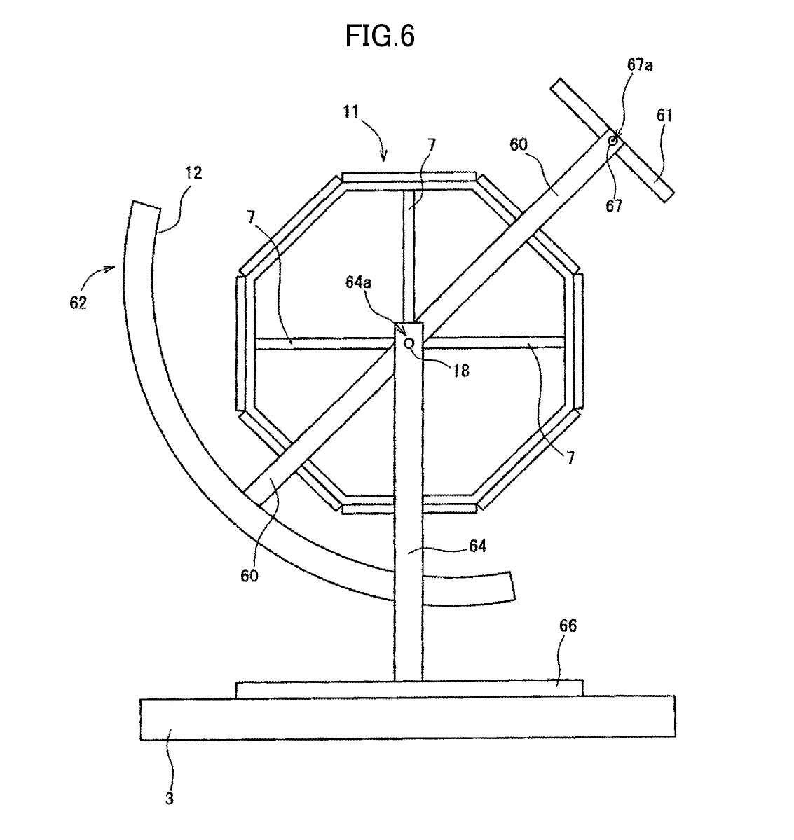

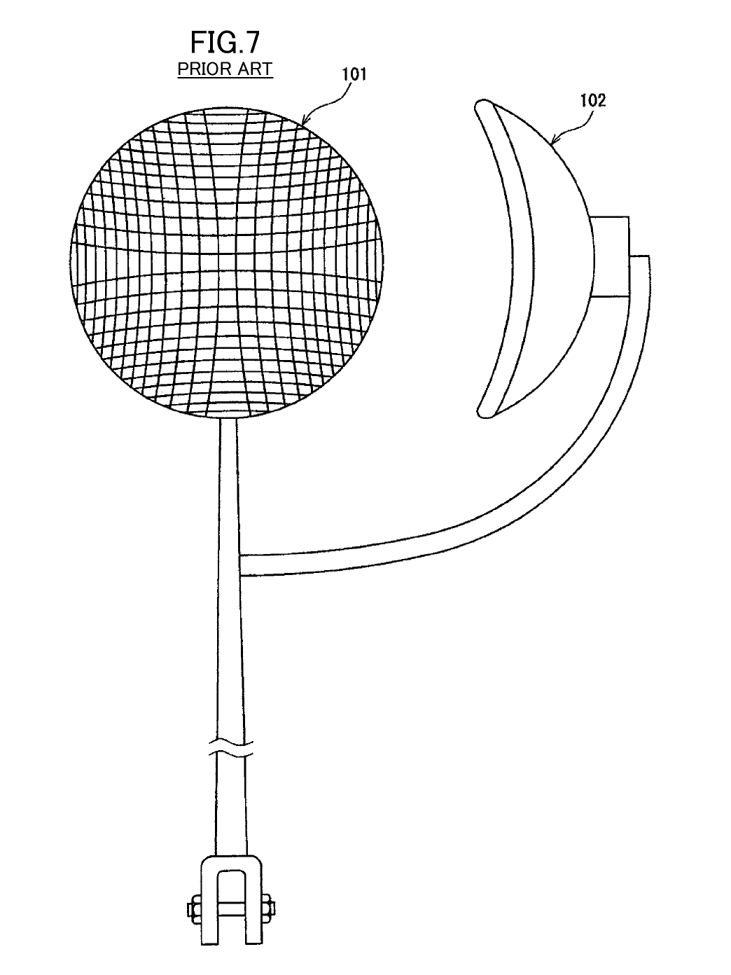

FIG. 6 shows a solar power generation apparatus according to a sixth embodiment of the present invention, and the solar power generation apparatus includes a solar cell panel body 11, a curved mirror holder 62 holding a curved mirror 2, a Fresnel lens 6, a lens frame 61, a base 3, a swivel base 66, a strut 64, a sun position detecting means (not shown), a swivel base driving means (not shown), an arm rotation driving means (not shown), and a lens frame rotation driving means (not shown).

A periphery of the Fresnel lens 6 is held by the lens frame 61. A side surface central portion 67 of the lens frame 61 is installed at an arm 60, and the lens frame can be rotated around a shaft 67a which is parallel to the base 3 by the lens frame rotation driving means. The arm 60 perpendicularly extends from a side surface central portion of the curved mirror holder 62 and is installed at a shaft supporter 64a of a rotation shaft 18 so as to be rotated around the rotation shaft 18 by the arm rotation driving means. The strut 64 is vertically erected from the swivel base 66. The rotation plate 66 which is in a disk shape is installed on the base 3 and can be rotated in a circumferential direction by the swivel base driving means.

The swivel base driving means acquires an azimuth signal of the sun from the sun position detecting means and rotates the rotation plate 66 such that the solar cell panel body 11 faces the sun. The arm rotation driving means and the lens frame rotation driving means acquire an altitude signal of the sun from the sun position detecting means. The arm rotation driving means rotates the arm 60 such that a reflection surface 12 faces the sun, and the lens frame rotation driving means rotates the lens frame 61 so as to adjust an incidence angle of the sunlight to the Fresnel lens 6.

In the solar power generation apparatus according to the sixth embodiment, since the sunlight is collected at the solar cell panel body 11 using the Fresnel lens 6, power generation efficiency in a condensing range is increased, and power generation is efficiently performed even with a small area.

In addition, since the swivel base 66, the arm 60, and the lens frame 61 can be rotated depending on an azimuth and altitude of the sun detected by the sun position detecting means, the solar cell panel body 11 and the reflection surface 12 can face the sun at all times, and thereby power generation efficiency is improved. Further, by rotating the solar cell panel body 11, it is possible to prevent burn-out occurring because the sunlight collected by the Fresnel lens 6 is applied only to some of the solar cell panels 1.

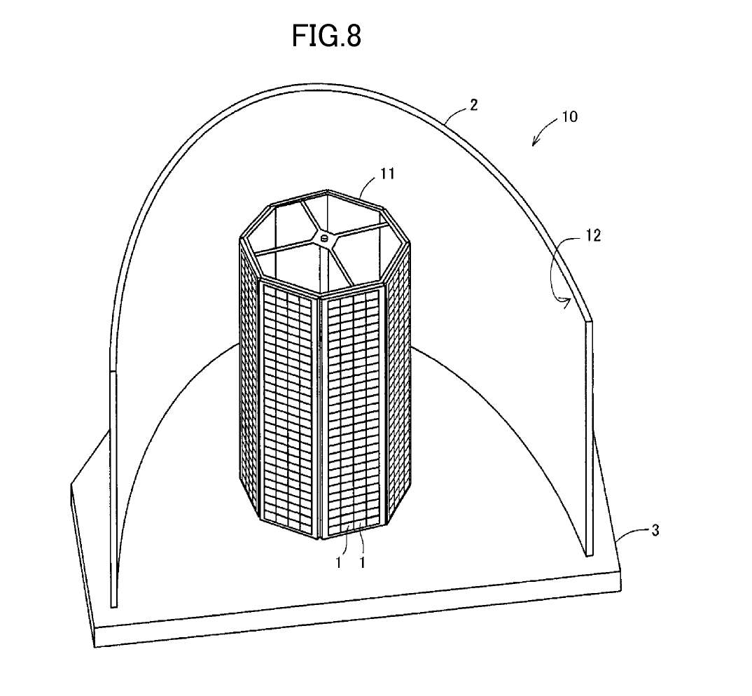

FIG. 8 shows a solar power generation apparatus 10 according to a seventh embodiment of the present invention, and the solar power generation apparatus 10 includes solar cell panels 1, a curved mirror 2 which is a reflection plate, and a base 3.

In the present embodiment as well, a solar cell panel body 11 is obtained by disposing the solar cell panels 1 in an octagonal prism shape. The solar cell panel body 11 may be obtained by disposing the solar cell panels 1 in a polygonal prism shape or a cylindrical shape other than the octagonal prism shape.

A shape of the curved mirror 2 is a semi-tube shape which reflects the sunlight at a reflection surface 12, and the reflection surface 12 is formed to be concaved. Thereby, the inside of the reflection surface 12 is in a groove shape which extends in an axial direction of the tube. The reflection surface 12 may be a specular reflective surface. In addition, the reflection surface 12 may be a diffuse reflective surface.

A transverse cross-section of the reflection surface 12 has any curved shape, and may have a parabolic shape, an elliptical shape, or any polygonal line shape (hyperbolic shape, or combination of straight lines) other than the parabolic shape. The reflection plate may be constituted by arranging plural small-sized mirrors. The curved mirror 2 is a glass mirror, but may be an acryl mirror, an aluminum mirror or a stainless steel mirror, and preferably has high reflectance.

The curved mirror 2 has a shape where a tube is divided into approximately two parts in an axial direction, and is erected on the base 3 in the vertical direction which is the axial direction thereof. In addition, the solar cell panel body 11 is fixed to the base 3 and is erected in a manner that its axial direction may be the vertical direction.

In the present invention, the vertical direction is a direction visually confirmed as a vertical direction to the horizontal surface and is a direction of a rising angle of 45 degrees or more with respect to the horizontal surface. A horizontal direction is a direction perpendicular to the vertical direction.

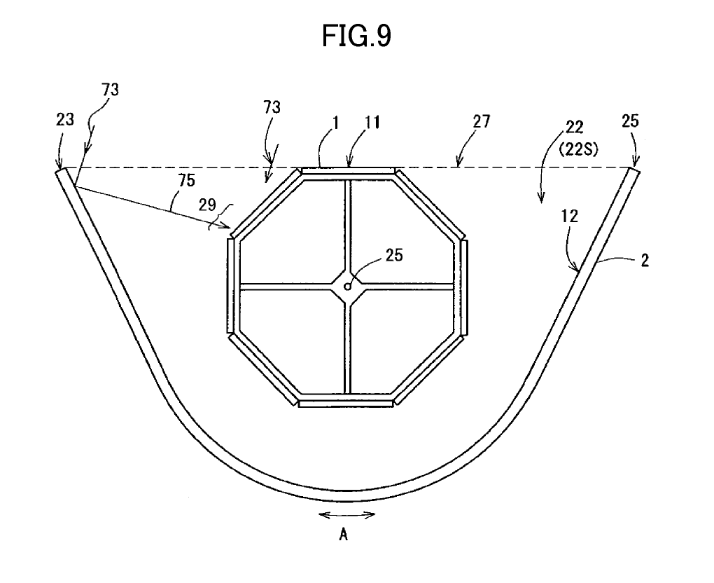

In the solar power generation apparatus according to the seventh embodiment, as shown in the arrangement view (top view) of FIG. 9, 80% or more of the light receiving surfaces of the solar cell panel body 11, that is, the light receiving surfaces of the solar cell panels are located in a space 22 with a groove shape formed inside the curved mirror 2. That is to say, 80% or more of the light receiving surfaces of the solar cell panel body 11 are located in an inner space 22S between a virtual plane 27 over two sides 23 and 25 parallel to the axial direction of the curved mirror 2 and the reflection surface 12.

With this configuration, the sunlight is directly incident to the solar cell panel body 11 and 50% or more of the light receiving surfaces of the solar cell panel body 11 receive light reflected from the curved mirror 2. Therefore, a power generation amount is increased, and thus it is possible to perform efficient power generation. In addition, there are many solar cell panels which directly receive the sunlight and receive light reflected from the curved mirror 2, thereby contributing to improvement of power generation efficiency. For example, a region 29 of the solar cell panel body 11 to which sunlight 73 is directly incident is irradiated with reflected light 75.

If a ratio of the light receiving surfaces located in the inner space 22S of the light receiving surfaces of the solar cell panel body 11 is less than 80%, there are few solar cell panels which directly receive the sunlight and receive light reflected from the curved mirror 2, and favorable power generation efficiency cannot be obtained.

In addition, in the seventh embodiment, the solar cell panels 1 are disposed in a tube shape, and thus it is possible to reduce the installation area of the solar cell panels 1.

In the solar power generation apparatus according to the seventh embodiment of the present invention, in FIG. 9, the curved mirror 2 is rotated in a direction of an arrow A along an approximately circular trajectory having the shaft (tube shaft) of the solar cell panel body 11 as an axis 25. It is possible to adjust a direction of the reflection plate according to a horizontal azimuth of the sun through this rotation. Therefore, it is possible to perform solar power generation by directly receiving the sunlight and reflecting the sunlight more efficiently. Further, in the present specification, the same reference numerals through the drawings indicate the same or equivalent members.

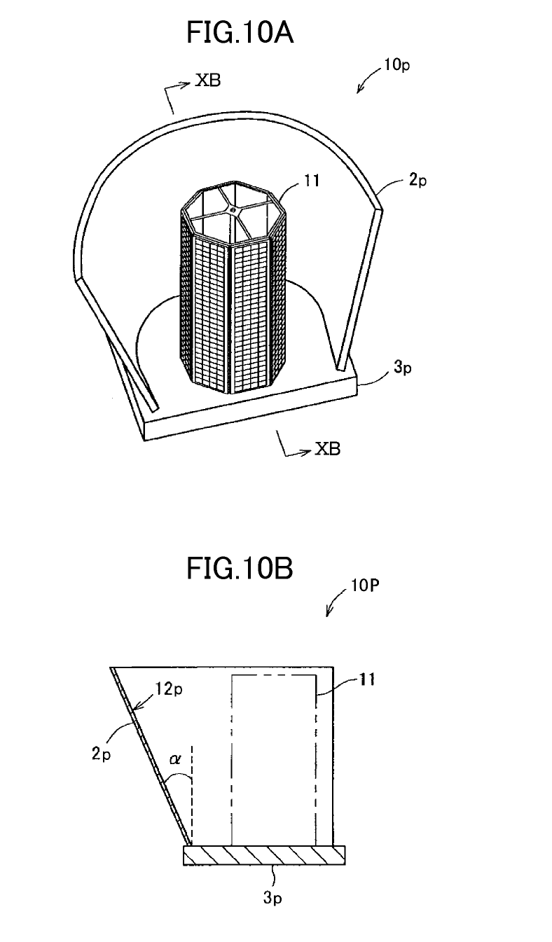

An example of another aspect of the seventh embodiment is shown in FIGS. 10A and 10B. In a solar power generation apparatus 10p shown in FIGS. 10A and 10B, a curved mirror 2p is used instead of the curved mirror 2 in the solar power generation apparatus 10 shown in FIG. 8. The curved mirror 2p has a shape where a tube having a circumferential surface shape of a circular truncated cone is divided into approximately two parts in an axial direction, and is erected on a base 3p in a manner that its axial direction may be the vertical direction. An angle α formed between the surface of the base 3p and a reflection surface 12p of the curved mirror 2p is 5 to 30 degrees. In this aspect, power generation efficiency is high when the sun is high.

In addition, in the present specification, the tube is defined to include a tubular object of which the thickness is different in the axial direction.

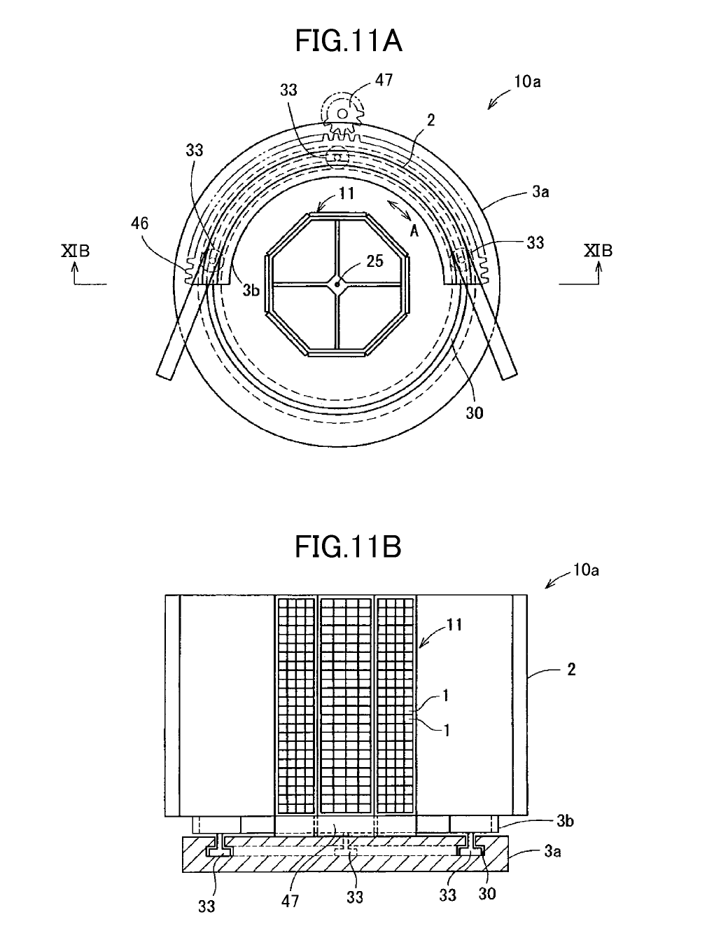

An example of an aspect of a solar power generation apparatus according to an eighth embodiment is shown in FIGS. 11A and 11B. In FIGS. 11A and 11B, a solar power generation apparatus 10a includes a solar cell panel body 11, a curved mirror 2, a fixed base 3a, and a movable base 3b. The solar cell panel body 11 is fixed and erected on the fixed base 3a installed at the ground when an axis 25 (tube shaft) is in the vertical direction. The curved mirror 2 is erected on the movable base 3b which is semicircular when viewed from the upper surface.

The upper surface of the fixed base 3a is provided with a guide groove 30 which has the axis 25 as the center of the curvature and is semicircular when viewed from the upper surface. A cross-sectional shape of the guide groove 30 is a reverse T shape. A guide frame 33 is installed at the lower surface of the movable base 3b. The guide frame 33 is fitted to the guide groove 30, is guided to the guide groove 30, and can be moved in an arch trajectory in the horizontal direction. Thereby, the movable base 3b can be rotated in a direction of an arrow A, and the curved mirror 2 is rotated in the direction of the arrow A so as to be moved around the outside of the solar cell panel body 11 along an approximately circular trajectory having the shaft of the solar cell panel body 11 as the axis 25 in the same manner as the aspect shown in FIG. 9. A gear train 46 is formed on the outer circumference of the movable base 3b, and the gear train 46 is engaged with driving gears 47 which are rotatably driven by a rotating driving means (not shown). Thereby, the movable base 3b is driven so as to be rotated in the direction of the arrow A.

The rotating driving means may rotate the driving gears 47 manually or using a motor or the like, or may use some of power obtained through the solar power generation. The movable base 3b may be directly driven by the rotating driving means.

According to the solar power generation apparatus 10a, it is possible to uniformly adjust deterioration in the solar cell panels 1 by preventing the sunlight from being directly incident only to some of the solar cell panels 1 and it is possible to optimize a light reception amount by moving the curved mirror 2 according to the position of the sun.

As the motor used for the rotating driving means, a stepping motor or the like which can control a rotation angle is preferable. The driving means is preferably electrically connected to the sun position detecting means (not shown) so as to communicate with each other. In this case, the rotating driving means is operated in response to a signal output from the sun position detecting means. The operation may be performed using some of the power obtained through the solar power generation.

The sun position detecting means includes a photodiode as a sensor, detects the position (azimuth and altitude) of the sun, and outputs a signal indicating the position. When the position of the sun cannot be detected due to the cloudy weather, the position of the sun may be predicted using a predefined calculation formula, the date, and installation place information.

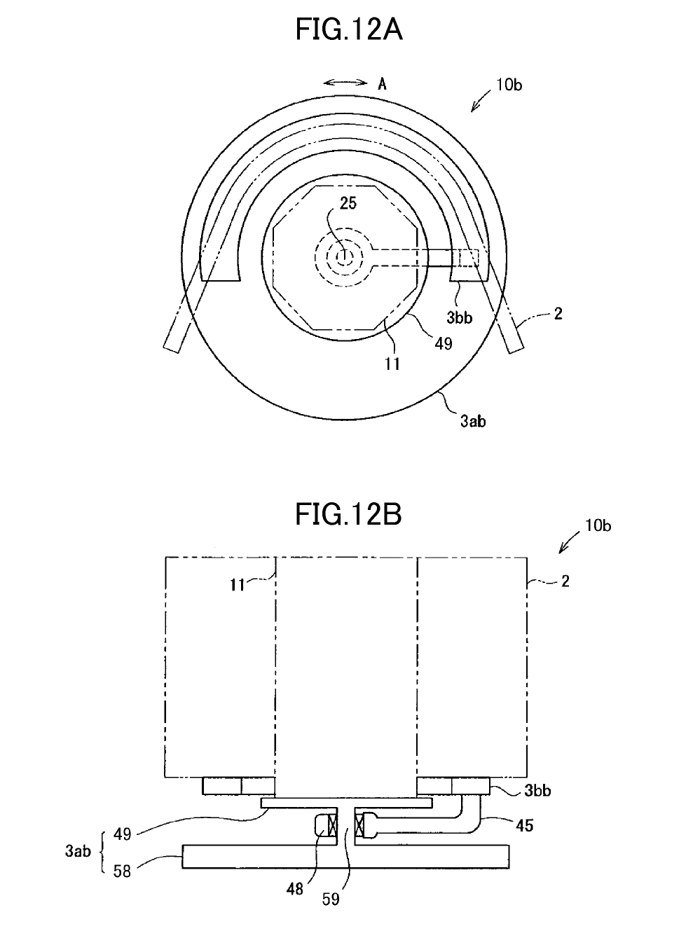

Another example of the aspect of the eighth embodiment is shown in FIGS. 12A and 12B. In FIGS. 12A and 12B, a solar power generation apparatus 10b includes a solar cell panel body 11, a curved mirror 2, a fixed base 3ab, and a movable base 3bb which is semicircular when viewed from the upper surface. The solar cell panel body 11 is fixed and erected on an upper base 49 which has a disc shape and is installed at the ground so as to be parallel thereto in the vertical direction which is a direction of an axis 25. The curved mirror 2 is erected on the movable base 3bb which is semicircular when viewed from the upper surface.

The fixed base 3ab includes the disc-shaped upper base 49 and a disc-shaped lower base 58. The upper base 49 and the lower base 58 share an axis of the two and are disposed so as to be parallel to each other with a gap, and are connected to each other via a round shaft 59 coaxial with the axis. On the other hand, the movable base 3bb is rotatably fitted to the round shaft 59 via a connection shaft 45 and a bearing 48, and can be rotated around the round shaft 59, that is, the axis 25. Thereby, the curved mirror 2 is rotated in a direction of an arrow A so as to be moved around the outside of the solar cell panel body 11 along an approximately circular trajectory having the shaft of the solar cell panel body 11 as the axis 25 in the same manner as the aspect shown in FIG. 9. The movable base 3bb is driven by a driving means (not shown).

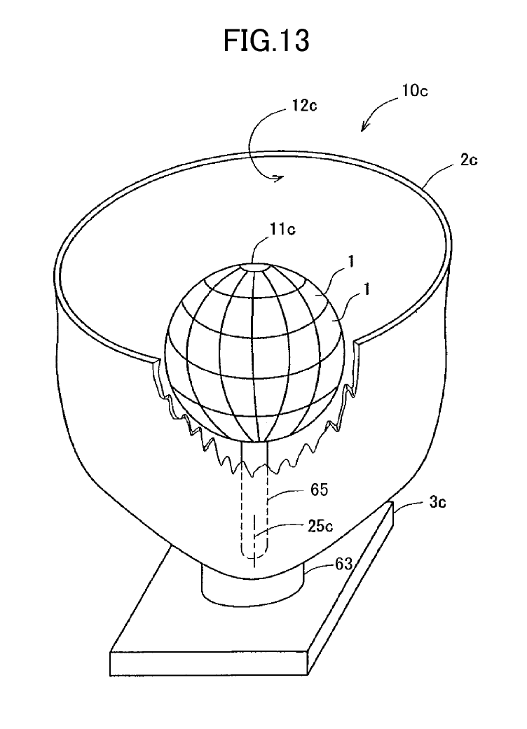

In a solar power generation apparatus according to a ninth embodiment of the present invention, in FIG. 13, a solar power generation apparatus 10c includes a solar cell panel body 11c, a curved mirror 2c, and a fixing base 3c which fixes the curved mirror 2c. The curved mirror 2c has a bowl shape which is open upwardly and has an inner surface as a reflection surface 12c, and is fixed on the fixing base 3c installed at the ground via a pedestal 63 in the vertical direction which is a direction of an axis 25c. The solar cell panel body 11c is fixed above the bottom of the curved mirror 2c via a fixing member 65.

The bowl shape is a shape of one side when a convex closed surface is cut in round slices outwardly.

A longitudinal cross-section of the curved mirror 2c has any curved shape, and may have a parabolic shape, an elliptical shape, or any polygonal line shape (hyperbolic shape, or combination of straight lines) other than them. The reflection plate may be constituted by arranging plural small-sized mirrors.

An open surface or a transverse cross-section of the curved mirror 2c is preferably circular. A polygonal shape may be employed.

The solar cell panel body 11c is obtained by disposing solar cell panels 1 in an approximately spherical shell shape. The solar cell panel body 11c may be obtained by disposing the solar cell panels 1 in a polyhedral shell shape or in an approximately spheroidal shell shape.

In addition, the spheroid is a solid occurring when a single elliptical plane is rotated with respect to an axis of rotation existing therein, but, in the present invention, the sphere or the spheroid is not necessarily an exact shape geometrically, and the approximately spherical shell shape or the approximately spheroidal shell shape refers to one which can be recognized as a spherical shell shape or a spheroidal shell shape visually, and a close surface shape which is inscribed or circumscribed around a polyhedral shell.

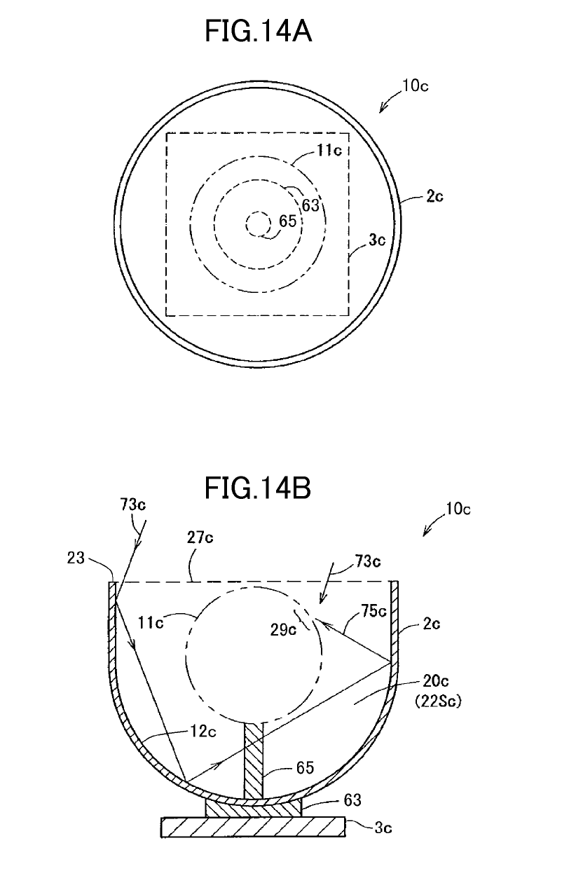

In the solar power generation apparatus according to the ninth embodiment, as shown in the arrangement views of FIGS. 14A and 14B, 80% or more of the light receiving surfaces of the solar cell panel body 11c, that is, the light receiving surfaces of the solar cell panels are located in an inner space 22c of a hollow-shaped space (hollow 20c) formed inside the curved mirror 2c. That is to say, 80% or more of the light receiving surfaces of the solar cell panel body 11c are located in an inner space 22Sc between a virtual plane 27c including an upper side 23 of the curved mirror 2c moved in the horizontal direction and the reflection surface 12c.

With this configuration, since 50% or more of the light receiving surfaces of the solar cell panel body 11c receive light reflected from the curved mirror 2c, a power generation amount is increased, and thus it is possible to perform efficient power generation. In addition, since the solar cell panels 1 are disposed in an approximately spherical shell shape, in a polyhedral shell shape, or in an approximately spheroidal shell shape, there are many solar cell panels which directly receive the sunlight and receive light reflected from the curved mirror 2c, thereby contributing to improvement of power generation efficiency. For example, a region 29c of the solar cell panel body 11c to which sunlight 73c is directly incident is irradiated with reflected light 75c.

If a ratio of the light receiving surfaces located in the inner space 22c of the light receiving surfaces of the solar cell panel body 11c is less than 80%, there are few solar cell panels which directly receive the sunlight and receive light reflected from the curved mirror 2c, and favorable power generation efficiency cannot be obtained.

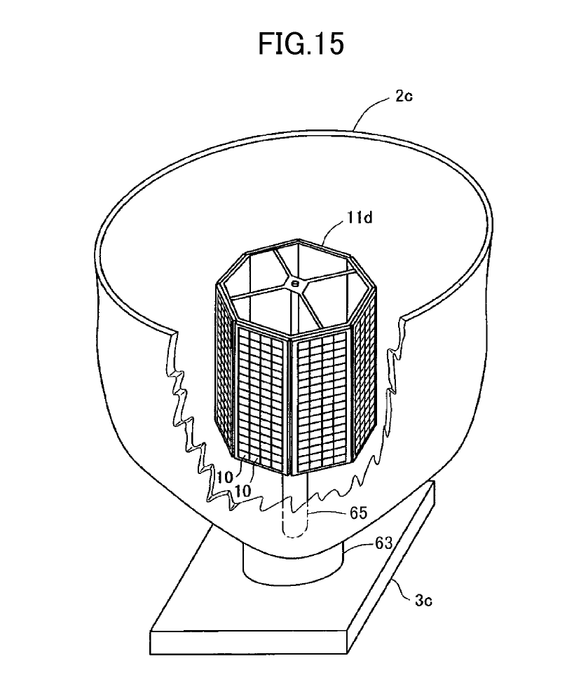

FIG. 15 shows an aspect of another example of the solar power generation apparatus according to the tenth embodiment. In FIG. 15, a solar cell panel body 11d where solar cell panels 1 are disposed in a cylindrical shape is used instead of the solar cell panel body 11c in the aspect of FIG. 13. In the aspect as well, it is possible to perform efficient power generation.

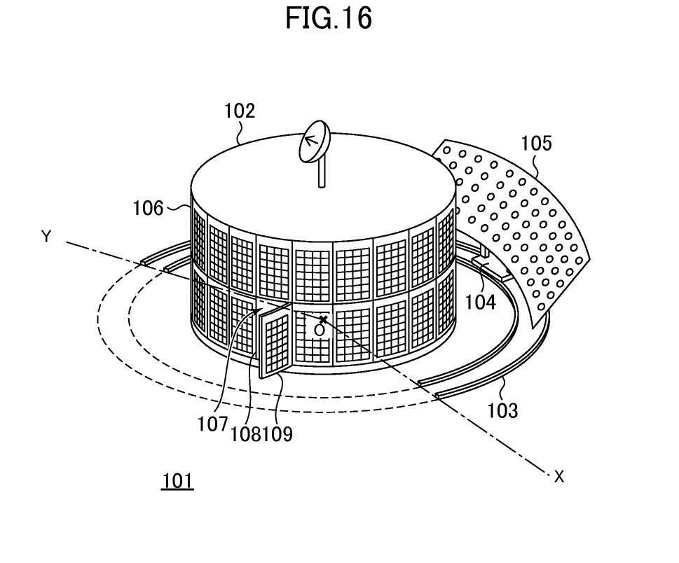

FIGS. 16 to 21 shows a solar photovoltaic facility as the eleventh embodiment of the present invention. FIG. 16 shows a schematic perspective view of the solar photovoltaic facility 101 of this embodiment of the present invention.

The solar photovoltaic facility 101 includes: a construction 102 having practically cylindrical shape with a vertical axis; a guide 103 partially encompassing an outer periphery of the construction 102 and is practically concentric with the construction 102; and a reflector 105 supported by a movable mount 104 riding on along the guide 103 and movably guided by the guide 103.

The construction 102 has practically cylindrical shape and its sidewall surface is vertical. In this specification, “practically cylindrical shape” means a cylindrical form or a polygonal column which is equal to or more than a hexagonal column. Furthermore, the construction 102 should be regarded as to have practically cylindrical shape when the construction 102 can be evaluated to be a cylindrical form or a polygonal column which is equal to or more than a hexagonal column even when the construction 102 has a partial protrusion or a cutout.

A plurality of solar panels 106 is attached on the sidewall of the construction 102. Inside of the construction 102 is a utility space 107 which can be utilized for various usages. An entrance 108 provided in apart of the sidewall allows an access to the utility space 7 from outside. The entrance 108 has a door 109 and the solar panel 6 is also attached on an outer surface of the door 109. Therefore, in a state the door 109 closes, almost all of the sidewall surface of the construction 102 will be covered with the solar panels 6.

The construction 102 may be designed and built for each time depending on a plat where the photovoltaic facility 1 should be placed. Or, the construction 102 may be built by assembling components at the installation site, the components into which the construction 102 have been modularized have been pre-fabricated at a factory, that is, made by so-called prefabrication method. Moreover, each component can be made as quick-joint and release to enable trucking dissolved construction 102 as necessary.

The utility space 107 of the construction 102 accommodates subsidiary devices of the solar panels 106, such as a power conditioner, and arbitrary electric devices in use. The solar panels 106 can supply the power consumed by these devices in whole or a part. This means no facility other than the solar photovoltaic facility 101 for accommodating some devices basically needs to be built. FIG. 16 shows a communications parabolic antenna on a rooftop, the utility space 107 is presumed to accommodate communication equipments such as a satellite phone.

The guide 103 is a track for guiding the movable mount 104. Specifically, the guide 103 can be a pair of rails made of metals, concrete or other arbitrary materials, or others. In this embodiment, the guide 103 is a pair of concrete rails. The guide 103 has an arc shape centered at a center O of the construction 102 and partially surrounds an outer periphery of the construction 102. FIG. 16 shows parts of circles on which the guide 103 is not provided in broken lines, the circles on which the guide 103 should be located. The guide 103 is provided from a direction X to a direction Y through a back portion in the FIG. 16. Described later in its details, the direction X and the direction Y are set based on the solar trajectory in latitude at a place where the construction 102 is built.

The movable mount 104 is a mount which is guided by the guide 103 and moves running on the guide 103. The reflector 105 is mounted on the movable mount 104 and moves around the construction 102 together with the movable mount 104, rotating with the center O as its center of movement. Moreover, the reflector 105 is adjustable in an angle to the vertical direction. Detailed structures of the movable mount 104 and the reflector 105 will be described later.

The reflector 105 is a mirror which reflects sunbeam toward the solar panels 106 attached on the sidewall of the construction 102. The reflector 105 preferably turns the direction of the sunbeam, incoming as parallel light, toward the construction 102 by reflection. The reflector 105 may be preferably a concave mirror as illustrated or a Fresnel mirror. The reflector 105 exemplified in this embodiment has cylindrical surface shape.

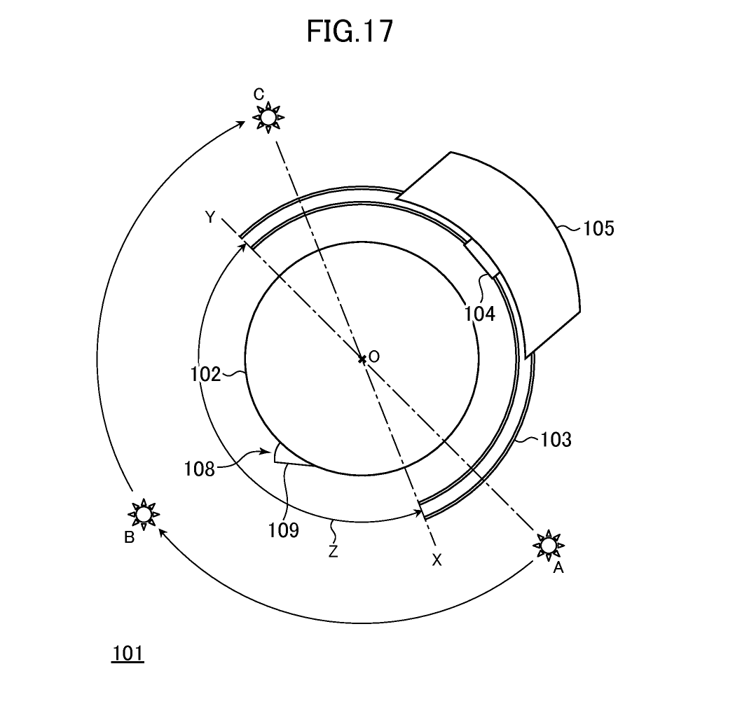

FIG. 17 shows schematic plan view of the solar photovoltaic facility 101 according to the embodiment of the present invention. The figure shows the guide 3 partially surrounding the outer periphery of the approximately circular construction 102 in plan view. The movable mount 104, which is guided by and movable on the guide 103, and the reflector 105 supported by the movable mount 104 are placed on the guide 103.

FIG. 17 further shows azimuths of the sunrise, the culmination and the sunset in the summer solstice at a place where the solar photovoltaic facility 101 is placed as symbols A, B and C respectively, together with the direction of the diurnal motion of the sun as an arrow. Shown is a case that the construction 102 is placed in the Northern Hemisphere, the azimuth of the culmination B directs true south. Also, the direction of the diurnal motion of the sun will be clockwise as illustrated. When the construction 102 is placed in the Southern Hemisphere, the azimuth of the culmination B will direct the opposite direction, and the direction of the diurnal motion of the sun will be counter-clockwise.

The movable mount 104 moves the reflector 105 to a directly opposite position against the azimuth of the sun centered at the center O of the construction 102. Considering a fact that the path of the diurnal motion of the sun in daytime becomes the longest in the summer solstice, the guide should be placed over a range in which the movable mount 104 should be guided at a place corresponding to the path of the diurnal motion of the sun in the summer solstice. Specifically, the guide 103 should placed at least from an azimuth Y opposite to the azimuth A of the sunrise in the summer solstice, through an azimuth opposite to the azimuth of the culmination B, to an azimuth X opposite to the azimuth C of the sunset in the summer solstice.

If the entrance 108 is installed at a position where the construction 102 faces the guide 103, the movable mount 104 and the reflector 105 will lie in front of the entrance 108 in certain time window, and may cause a difficulty in accessing the utility space 107. To avoid the situation, the entrance 108 is installed on the sidewall of the construction 102 within a range Z where the construction 102 does not face the guide 103. Thereby an access through the entrance 108 does not prevented by the guide 103, the movable mount 104 and the reflector 105.

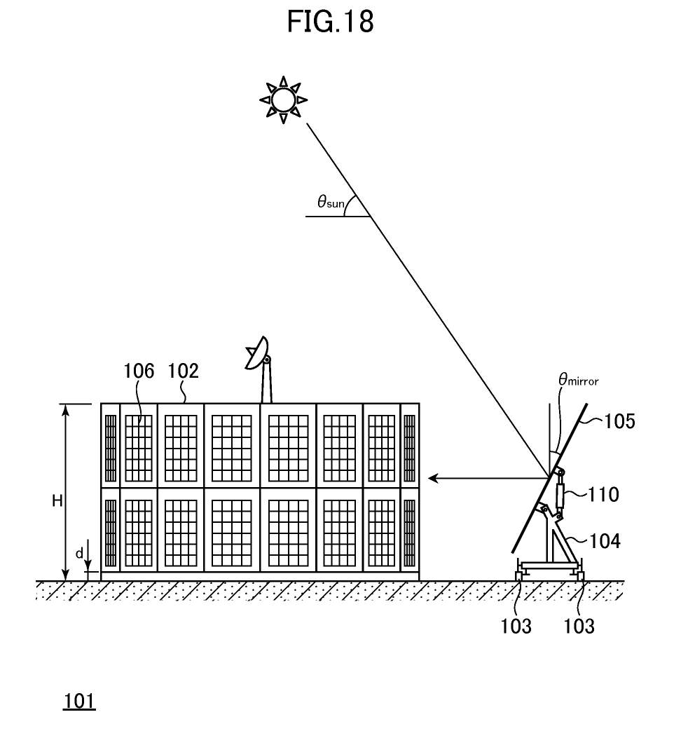

The movable mount 104 has a function of adjusting an angle of the reflector 105 from vertical direction. FIG. 18 shows schematic side view of the solar photovoltaic facility 101 according to this embodiment of the present invention. Now putting θsun as the elvation angle of the sun at certain moment, setting the angle of the reflector 105 from vertical direction as θsun/2 in a manner that the reflector 105 outspreads upwardly causes the sunlight reflected by the reflector 105 incomes the solar panels 106 exactly horizontally. In this embodiment, an angle adjuster 110 installed in the movable mount 104 adjusts the angle of the reflector 105 θmirror to be θsun/2 from hour to hour, thereby the sunlight efficiently incomes the solar panels 106 over a whole daytime. Also, the angle θmirror is adjusted in accordance with a seasonal change of the elevation angle of the sun, the solar photovoltaic facility 101 can utilize the sunlight in high efficiency throughout the year.

Meanwhile, the angle adjuster 110 is not necessarily one that automatically adjusts the angle of the reflector 105, but can be one that manually adjusts the angle of the reflector 105 to specific angle. The specific angle can be, for example, a half of the elevation angle of the sun at the culmination, or slightly less angle than that. An adjustment of the angle of the reflector 105 can be held per day, month or season.

The height of the construction 102 is preferably chosen equal to or less than four meter above the ground. The construction 102 is settled in open air, the surface of the solar panels 106 will be covered by dirt or dust, the surface of the solar panels 106 requires clean-up regularly or occasionally. If the height of the construction 102 is over four meter, cleaning task will have some difficulties. Of course the height of the construction 102 has no limit when accepting arduousness in the cleaning task. Or, an automatic cleaning machine or a kind of cleaning gondolas can be installed on the rooftop of the construction 102. In this case, a whole or a part of power for this automatic cleaning machine or gondolas can be supplied by the solar panels 106.

The solar panels 106 of the solar photovoltaic facility 101 are primitively dirt or dust repellent because they are positioned vertically. Moreover, the solar panels 106 is preferably placed by clearance d above the ground, intended to be more repellent from dirt or dust covering by, for example, dirt splattering caused by raindrops. The clearance d is chosen preferably in between 5 cm to 50 cm, more preferably 10 cm to 30 cm. The clearance d can be selected in consideration of a condition of the ground around the construction 102. For example, larger d will be selected for unpaved ground while smaller d will be selected for paved ground.

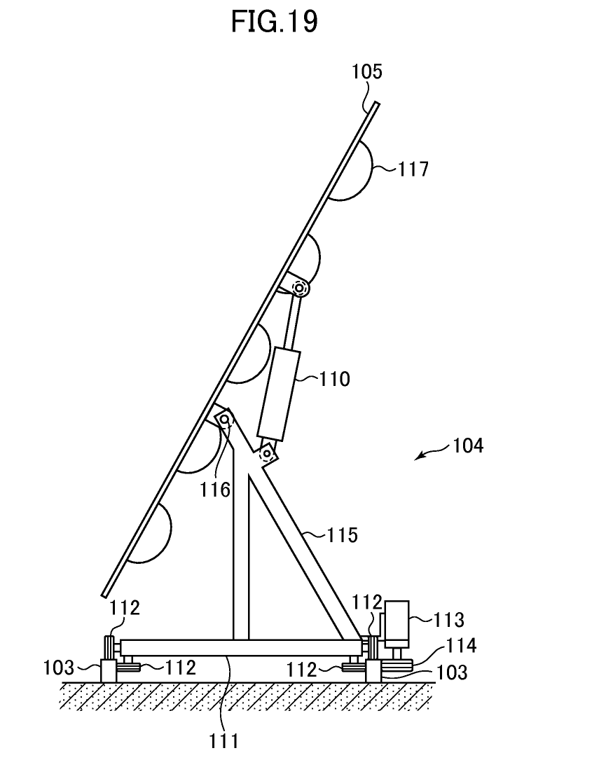

FIG. 19 shows a side view of the reflector 105 and the movable mount 104. A structure of the movable mount 104 is not limited to a specific one, this embodiment shows one exemplary structure in which guide wheels 112 are installed on a base 111, the base 111 is movably set on the guide 103 without outtracking, a driving actuator 113 is mounted on the base 111 with an appropriate bracket, and the movable mount 104 can be movably driven by that one of the guide wheels 112 in touch with the guide 103 is driven rotarily by the driving actuator 113. The driving actuator 113 is an electric motor, whole or a part of its power is supplied by the solar panels 106. The guiding mechanism or the driving mechanism of the movable mount 104 is not limited to the one shown in this embodiment, any known mechanism can be employed alternatively.

Also, a supporting frame 115 is erected on the base 111. The reflector 105 is rotatably supported by a pivot 116 installed at a tip of the supporting frame 115. The reflector 105 can rotate itself around the pivot 116 to change its angle thereby. More, the angle adjuster 110 bridges a distance between the supporting frame 115 and the reflector 105, and adjusts the angle of the reflector 105 by varying the length of the angle adjuster 110 itself. In this embodiment, the angle adjustor 110 is an electric actuator and whole or apart of its power is supplied by the solar panels 106. However, which kind of instrument should be used as the angle adjuster 110 is arbitrary. Moreover, the angle adjuster 110 is not necessarily b an automatic instrument. An appropriate manual device can be used as the angle adjuster 110, for example, a commonly-used turnbuckle.

In addition, diffusion structure 117, diffusing incoming sunlight, is provided on a reflecting surface of the reflector 105. This diffusion structure 117 scatters incoming sunlight and diverges its angle, thereby prevents reflected light from converging on particular polar panels 106, shows function of equalization differences in power generation among the solar panels 106. The diffusion structure 117 is arbitrary, but is a plurality of bowl-shaped recesses as shown in this embodiment.

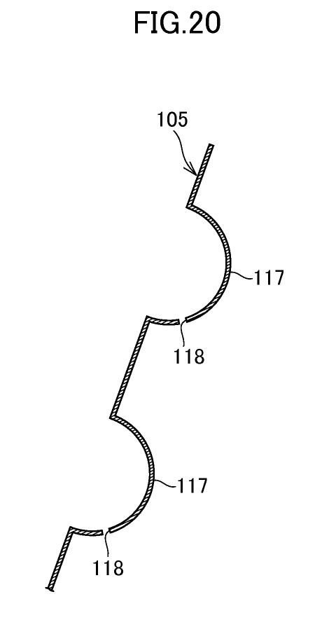

FIG. 20 shows a partial cross-sectional vertical view of the reflector 105 including the diffusion structure 117. In this embodiment, the bowl-shaped recess constructing the diffusion structure 117 is a concave face of apart of a spherical shell shape. Additionally, in a lower part of the bowl-shaped recess, namely, at least in lower half thereof, a drain hole 118 is provided. This drain hole 118 is for preventing deterioration in reflective performance of the reflector 105, caused by water, coming by e.g. rain, pooling in or dirt or dust piling in the bowl-shaped recess.

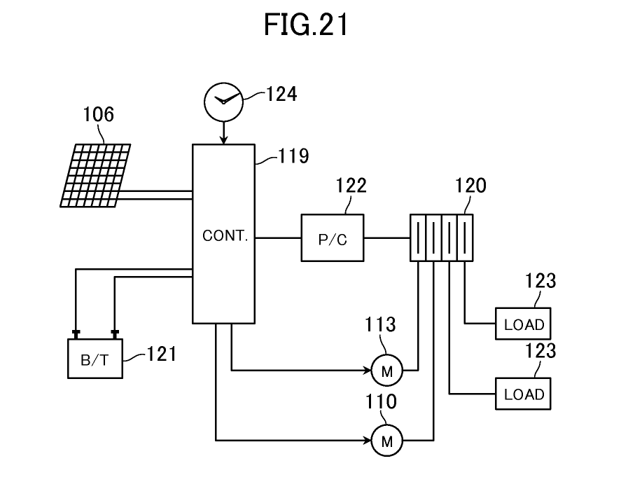

FIG. 21 shows a schematic electric system diagram of the solar photovoltaic facility 101 according to this embodiment of the present invention. Power generated by the solar panels 106 is input to a controller 119. The controller 119 is a control panel which distributes the power generated by the solar panels 106 to a power distribution board 120 and a secondary battery 121 and controls various automated instruments used in the solar photovoltaic facility 101.

A part of the power distributed by the controller 119 is accumulated in the secondary battery 121. Also, another part of the power is distributed to a power conditioner 122, converted into AC same as mains electricity and supplied to the power distribution board 120. Each of the driving actuator 113 and the angle adjuster 110 is connected to the power distribution board 120 and driven in accordance with signals from the controller 119. Moreover, any arbitrary load 123 can be connected to the power distribution board 120 and used.

The controller 119 charges the secondary battery 121 to accumulate power using surplus power when the power generated by the solar panels 106 exceeds the power supplied from the power distribution board 120. Contrarily, when the power generated by the solar panels 106 goes insufficient for the power supplied from the power distribution board 120, e.g. loads are extremely large of in night or cloudy condition, the controller 119 turns the accumulated power in the secondary battery 121 into the power conditioner 122 to fill the shortage in power.

Also, the controller 119 controls the driving actuator 113 and the angle adjuster 110 to keep the position and the angle of the reflector 105 in proper state, based on information of current date and time input from a clock circuit 124. This control can be done continuously or periodically, for example, once per an hour. The clock circuit 124 can count not only current time but also current date. The controller 119 can compute precise azimuth and elevation angle of the sun from latitude where the solar photovoltaic facility 101 located and the information of current date and time.

Alternatively, the azimuth and the elevation angle of the sun may be obtained by detecting the sun using a sensor additionally installed. However, calculating based on the information of current date and time is more favorable because it could become difficult to detect the position of the sun in some cases, e.g. cloudy condition. Also, while the clock circuit 124 in this embodiment counts date and time continuously, the clock circuit 125 can obtain the information of current date and time by receiving a date and time information contained in a radio time signal at a requested timing with an appropriate antenna as an alternative, for example. Moreover, the secondary battery 121 can be omitted when power consumption in the solar photovoltaic facility 101 is limited only in daytime.

These devices, the controller 119, the power distribution board 120, the secondary battery 121 and the power conditioner 122 etc. are accommodated in the utility space 107 of the construction 102. Thereby, other facility for accommodating these devices is not required separately. Only placing the solar photovoltaic facility 101 allows immediate use of arbitrary electric powered devices.

While the solar photovoltaic facility 101 can be used in standalone manner, without connecting to outer power grid, the solar photovoltaic facility 101 may connect to the outer power grid, and sell excessive power when there is excess, and buy and receive complemental power when there is short.

As explained above, the solar photovoltaic facility 101 allows immediate use of arbitrary electric powered devices in standalone manner, and has no need to connect with outer power grid. Therefore, it can be used as a convenient facility which provides electric power use especially in non-electrified area.

In particular, the utility space 107 of the construction 102 of the solar photovoltaic facility 101 can be used for all-purposes, the solar photovoltaic facility 101 is potent in remarkably various and beneficial usages, such as a residence or a mountain lodge in back-country, a hub medical outpost in back-country installed with advanced medical equipments which require electric power, a communication site for a satellite phone for example, or a water supply which can supply safe water installed with a pump, which pumps up ground water, and a filtering apparatus, etc. Moreover, the equipments used for various purposes described above will be accommodated in the utility space 107 which is inside of the robust construction 102, pollution or deterioration of these equipments caused by open-air use will be free from concern.

In addition, the present invention may be implemented with aspects to which various alterations, corrections, or modifications are added according to the knowledge of a person skilled in the art within the scope without departing from the spirit thereof. Further, the present invention may be implemented in a form where an invention specifying matter is replaced with another technique within the scope achieving the same operation or effect.

What is claimed is:

1. A solar photovoltaic facility comprising:
a construction having practically cylindrical shape and an utility space internally;
a solar panel provided on cylindrical sidewall of the construction;
a guide partially encompassing the construction and is practically concentric with the construction in plan view;
a reflector movably guided by the guide and reflecting the sunlight towards the solar panel;
a driving actuator which moves the reflector to a position in a direction opposite to the azimuth of the sun viewed from the construction; and
an entrance installed on the sidewall of the construction within a range where the construction does not face the guide and accessible to the utility space.

2. The solar photovoltaic facility according to claim 1, wherein the guide guides the reflector at least from an azimuth opposite to the azimuth of the sunrise through an azimuth opposite to the azimuth of the culmination to an azimuth opposite to the azimuth of the sunset in the summer solstice in latitude at a place where the construction is built.

3. The solar photovoltaic facility according to claim 1 further comprising an angle adjuster adjusting an angle of the reflector from vertical direction.

4. The solar photovoltaic facility according to claim 3, wherein the angle adjuster is an actuator for angle adjustment.

5. The solar photovoltaic facility according to claim 4, wherein the actuator for angle adjustment adjusts the angle of the reflector from vertical direction to be a half of the elevation angle of the sun.

6. The solar photovoltaic facility according to claim 1, wherein the entrance has a door which the solar panel is provided on an outer surface of the door.

7. The solar photovoltaic facility according to claim 1, wherein diffusion structure diffusing sunlight is provided on a reflecting surface of the reflector.

8. The solar photovoltaic facility according to claim 7, wherein the diffusion structure is a plurality of bowl-shaped recesses provided on the reflecting surface.

9. The solar photovoltaic facility according to claim 8, wherein a drain hole is provided in a lower part of the bowl-shaped recess.

10. The solar photovoltaic facility according to claim 1, wherein the height of the construction is equal to or less than four meter.

11. The solar photovoltaic facility according to claim 1 further comprising:
a power conditioner; and
a control panel controlling the driving actuator,
wherein the utility space accommodates an electric powered device.

12. The solar photovoltaic facility according to claim 4 further comprising:
a power conditioner; and
a control panel controlling the driving actuator and the actuator for angle adjustment,
wherein the utility space accommodates an electric powered device.

13. The solar photovoltaic facility according to claim 11, wherein the utility space accommodates an secondary battery accumulating electric power generated by the solar panel.

14. The solar photovoltaic facility according to claim 12, wherein the utility space accommodates an secondary battery accumulating electric power generated by the solar panel.
